(19) United States
(12) Patent Application Publication
(10) Pub. No.: US 2010/0125717 A1
(43) Pub. Date: May 20, 2010

(54) Synchronization Controller For Multiple Multi-Threaded Processors

(76) Inventor: Mois Navon, Efrat (IL)

Correspondence Address: The Law Office of Michael E. Kondoudis, 888 16th Street, N.W., Suite 800, Washington, DC, 20006, US

(21) Appl. No.: 12/272,290

(22) Filed: Nov. 17, 2008

(51) Int. Cl. G06F 15/76; G06F 9/06

(52) U.S. Cl. 712/30; 712/E09.003

(57) ABSTRACT

A gated-storage system including multiple control interfaces, each control interface operatively connected externally to respective multithreaded processors. The multithreaded processors each have a thread context running an active thread so that multiple thread contexts are running on the multithreaded processors. A memory is connected to a system-level inter-thread communications unit and shared between the multithreaded processors. The thread contexts request access to the memory by communicating multiple access requests over the control interfaces. The access requests are from any of the thread contexts within any of the multithreaded processors. A single request storage is shared by the multithreaded processors. A controller stores the access requests in the single request storage within a single clock cycle.

### BACKGROUND

1. Technical Field

The present invention relates to multi-processing using multiple processors, in which each processor is capable of supporting multiple threads. Specifically, the present invention relates to a system and method for inter-thread communications between the threads of the various processors in the system.

2. Description of Related Art

Multiprocessing systems continue to become increasingly important in computing systems for many applications, including general purpose processing systems and embedded control systems. In the design of such multiprocessing systems, an important architectural consideration is scalability. In other words, as more hardware resources are added to a particular implementation the machine should produce higher performance. Not only do embedded implementations require increased processing power, many also require the seemingly contradictory attribute of providing low power consumption. In the context of these requirements, particularly for the embedded market, solutions are implemented as “Systems on Chip” or “SoC.” MIPS Technologies, Inc., ARM, PowerPC (by IBM) and various other manufacturers, offer such SoC multiprocessing systems. In multiprocessing systems, loss in scaling efficiency may be attributed to many different issues, including long memory latencies and waits due to synchronization of thread processes.

Synchronization of processes using software and hardware protocols is a well-known problem, producing a wide range of solutions appropriate in different circumstances. Fundamentally, synchronization addresses potential issues that may occur when concurrent processes have access to shared data. As an aid in understanding, the following definitions are provided:

The term “multiprocessing” as used herein refers to the ability to support more than one processor and/or the ability to allocate tasks between the multiple processors. A single central processing unit (CPU) on a chip is generally termed a “core” and multiple central processing units which are packaged on the same die are known as multiple “cores” or “multi-core”. The term “symmetric multiprocessing” (SMP), as used herein refers to a multiprocessor computer architecture where two or more identical processors are connected to a single shared main memory. Common multiprocessor systems today use an SMP architecture. In the case of multi-core processors, the SMP architecture as applied to the cores, treats the cores as separate processors.

The term “thread” as used herein is a sequential instruction stream. Many conventional processors run a single thread at a time. A “multithreaded processor” runs multiple threads at a time. A “hardware thread” or “thread context” as used herein, is the processor hardware state necessary to instantiate a thread of execution of an application instruction stream. The thread context includes general purpose registers (GPRs) and program counter.

A “virtual processing element” (VPE) is a CPU which includes the processor state and logic necessary to instantiate a task. The VPE is an instantiation of a full architecture and elements, including privileged resources, sufficient to run a per-processor operating system image. In a MIPS processor, the set of shared CP0 registers and the thread contexts affiliated with them make up a VPE (Virtual Processing Element).

A virtual multiprocessor is a collection of interconnected VPEs. The virtual processor is “virtual” in the sense that a multiprocessor system usually refers to a system with several independent processors, whereas here a single core instantiates several VPEs. The VPEs in such a system may, or may not, implement multithreads.

The term “gating memory”, “gating storage”, “gated memory”, and “gated storage” are used herein interchangeably and refer to data storage elements (e.g. memory, registers) which are not directly accessible except through logic circuitry which manages the access from multiple agents.

U.S. Patent Publication No. US2005/0251639 discloses a synchronization between threads of different processors of the same manufacturer—in this case MIPS. The synchronization of threads requires another layer of intercommunications of their respective processor. This intercommunication is needed, among other things, primarily to arbitrate access to the shared resource (i.e., the gated memory).

Improvements to synchronization among threads in a multithreaded multiprocessing environment is desirable, particularly when individual threads may be active on more than one multiple processors; additionally the prior art does not allow for multiple processors from different manufacturers to be synchronized together.

There is thus a need for, and it would be highly advantageous to have, a system and method for synchronization between thread contexts of a system on a chip including multiple multithreaded processors.

By way of example, reference is now made to FIGS. 1 and 1A which schematically illustrate a conventional multithreaded processor 105 of MIPS architecture. In processor 105 that is compatible with the industry-standard MIPS32K and/or MIPS64K Instruction Set Architectures (a “MIPS Processor”), a thread context 115 includes a state of a set of general purpose registers 19, Hi/Lo multiplier result registers, a representation of a program counter 17, and an associated privileged system control state. In the MIPS architecture, thread context 115 shares resources 18 with other thread contexts 115 including the CP0 registers used by privileged code in an Operating System (OS) kernel 16. Thread contexts 115 provide the hardware states to run processes 14a-14e in one-to-one correspondence with thread contexts 115a-115e. A MIPS processor is composed of a least one independent processing element referred to as a Virtual Processing Element (“VPE”) 12. A VPE includes at least one thread context 115. Processor 105 contains a number of VPEs 12, each of which operates as an independent processing element through the sharing of resources 18 in processor 105 and supporting an instruction set architecture. The set of shared CP0 registers and affiliated thread contexts 115 make up VPE 12. To software, a single core MIPS processor 105 with 2 VPEs 12 looks like a symmetric multiprocessor (“SMP”) with two cores. This allows existing multiple SMP-capable operating systems 16 (OS0, OS1) to manage the set of VPEs 12, which transparently share resources 18. In processor 105, two VPEs 12 are illustrated, VPE 12A includes thread contexts 115a and 115b, and VPE 12B includes thread contexts 115c, 115d and 115e.

Multithreaded programs can be running more threads than there are thread contexts on a VPE 12, by virtualizing them in software such that at any particular point during execution of a program, a specific thread is bound to a particular thread context 115. The number of that thread context 115 provides a unique identifier (TCID) to corresponding thread 14 at that point in time. Context switching and migration can cause a single sequential thread 14 of execution to have a series of different thread contexts 115 at different times.

Thread contexts 115 allow each thread or process 14 to have its own instruction buffer with pre-fetching so that the core can switch between threads 14 on a clock-by-clock basis to keep the pipeline as full as possible. Thread contexts 115 act as interfaces between VPE 12 and system resources. A thread context 115 may be in one of two allocation states, free or activated. A free thread context has no valid content and cannot be scheduled to issue instructions. An activated thread context 115 is scheduled according to the implemented policies to fetch and issue instructions from its program counter 17. Only activated thread contexts 115 may be scheduled. Only free thread contexts may be allocated to support new threads 14. Allocation and deallocation of thread contexts 115 may be performed explicitly by privileged software, or automatically via FORK and YIELD instructions which can be executed in user mode. Only thread contexts 115 which have been explicitly designated as Dynamically Allocatable (DA) may be allocated or deallocated by FORK and YIELD.

An activated thread context 115 may be running or blocked. A running thread context 115 fetches and issues instructions according to the policy in effect for scheduling threads for processor 105. Any or all running thread contexts 115 may have instructions in the pipeline of the processor core at a given point of time, but it is not known in software precisely which instructions belong to which running threads 14. A blocked thread context is a thread context 115 which has issued an instruction which performs an explicit synchronization that has not yet been satisfied. While a running, activated thread context 115 may be stalled momentarily due to functional unit delays, memory load dependencies, or scheduling rules, its instruction stream advances on its own within the limitations of the pipeline implementation. The instruction stream of a blocked thread context 115 cannot advance without a change in system state being effected by another thread 14 or by external hardware, and as such blocked thread context 115 may remain blocked for an unbounded period of time.

A data storage contention issue arises when more than one thread context 115 tries to access the same storage element attached to processor 105. In order to address this issue, US2005/0251639 discloses an InterThread Communications Unit (ITU) which provides a mechanism for communication between thread contexts 115 using gating storage 110. US2005/0251639 is included herein by reference for all purposes as if entirely set forth herein.

Reference is now made to FIG. 1B, a simplified schematic block diagram of a system 100 of the prior art (shown in more detail in FIG. 2). Multiple MIPS processors 105 are connected to and share gated storage 110 through a signaling interface 225. Each MIPS processor 105 includes InterThread Communications Unit (ITU) 120 which together manage communications between MIPS processors 105 and gated storage 110. As shown in FIG. 1B, ITUs 120 are wired to drive and accept strobes from each other using a signaling interface 180.

Reference is now made to FIG. 2, a more detailed schematic block diagram of system 100 from US2005/0251639, which includes (N) multiple multithreaded processors 105ᵢ each coupled to a gating storage 110. Each processor 105ᵢ is capable of concurrent support of multiple thread contexts 115 that each issue instructions, some of which are access instructions into gating storage 110. An inter-thread communications unit (ITU) 120 manages these access instructions by storing access instructions in a request-storage 125, a buffer/memory inside ITU 120, and ITU 120 communicates with thread contexts 115 and other processor resources using one or more first-in first-out (FIFO) registers 130ₓ.

To allow for synchronization of various threads 14 that need to intercommunicate, inter-thread communication (ITC) memory 110 is used and is designed in order to allow threads 14 to be blocked on loads or stores until data has been produced or consumed by other threads 14. For example, if a thread 14 attempts to read a memory element, but the memory element has not as yet been written, then the read request remains “shelved” until the corresponding datum is available.

Processor 105ᵢ includes a load/store FIFO (FIFO 130_{L/S}) for transmitting information to ITU 120 and a data FIFO (FIFO_{DATA}) for receiving information from ITU 120. ITU 120 communicates with various resources 18 of its processor 105ᵢ through FIFOs 130ₓ, such as for example with an arithmetic logic unit. (ALU), a load/store unit (LSU) and task scheduling unit (TSU) when communicating with various thread contexts 115. Further structure and a more detailed description of the operation of ITU 120 are provided below in the discussion of FIG. 3. The main responsibility of the TSU is to switch threads. While the following description makes use of these LSU/ALU/TSU functional blocks, these blocks and the interdependence of these blocks are but one example of an implementation of processor 105. In a broad sense, gating storage 110 is a memory, and ITU 120 is a controller for this memory and the manner by which a memory controller communicates to its memory and to a processor may be implemented in many different ways.

Gating storage 110, in a generic implementation, may include one or both of two special memory locations: (a) inter-thread communications (ITC) storage memory 150, (b) a FIFO gating storage 155. Access instructions executed by ITU 120 can initiate accesses to Memory 150 from a particular data location using one of the associated access method modifiers for that particular data location.

FIFO gating storage 155 allows threads in multithreaded processor 105 to synchronize with external events. The data of storage memory 150 enables thread-to-thread communication and the data of FIFO gating storage 155 enables thread-to-external event communication. FIFO gating storage 155 includes FIFOs 160 for communications in these data driven synchronization activities.

The fundamental property of thread context storage 110 is that loads and stores can be precisely blocked if the state and value of the cell do not meet the requirements associated with the view referenced by the load or store. The blocked loads and stores resume execution when the actions of other threads of execution, or possibly those of external devices, result in the completion requirements being satisfied. As gating storage references, blocked thread context loads and stores can be precisely aborted and restarted by system software.

ITU 120 accepts commands (read, write, kill request) from various thread contexts 115 and responds according to the status of the target memory device. A thread context 115 that is waiting for a response can kill its request using the kill command which is sent along with its thread context identifier (TCID).

Reference is now made to FIG. 3, a schematic block diagram from US2005/0251639 illustrating more detail of ITU 120 coupled to gating storage 110 as shown in FIG. 2. ITU 120 includes request storage 125 and a controller 200 coupled to both request storage 125 and to an arbiter 205. A multiplexer 210, coupled to an output of request storage 125, selects a particular entry in request storage 125 responsive to a selection signal from arbiter 205. ITU 120 receives and transmits data to thread contexts 115 shown in FIG. 2 using multiple data channels 215, including a status channel 215_{STATUS} and a LSU data channel 215_{LSU} through a processor interface 220. Data channels 215ₓ use one or more FIFOs 130ₓ shown in FIG. 2. ITU 120 has a command/response protocol over interface 220 with respect to LSU and a status/kill protocol over interface 220 to thread contexts 115 within its particular processor 105ᵢ (i.e., every processor 105 has its own unique ITU 120). Signaling interface 215 includes general signals (clock, reset), standard memory signals (address, byte enables, data), command signals (read, write, kill) as well as the thread context specific signals (TCID and response TCID).

Additionally, ITU 120 communicates with gating storage 110 (denoted in FIG. 3 as “Access Control Memory”) and with other ITUs 120 in processors 105ᵢ using an external interface 225. Controller 200 manages internal interfaces to thread contexts 115 using processor interface 220 (through the LSU/status channels for example) and to external (external to each processor 105ᵢ) interfaces (such as gating storage 110 and other ITUs 120 of other processors 105ᵢ).

ITU 120 accepts loads/stores (LDs/STs), after any required translation, from an LSU. The LSU detects whether any particular load or store is happening to an ITC page (these pages exist in gating storage 110) based on a decode in the physical memory space. These LD/ST “requests” are included within the scope of the term “memory access instruction” as used herein. Controller 200 manages the storage and retrieval of each memory access instruction in request storage 125. Request storage 125 of the preferred embodiment has N_{TC} number of entries, where N_{TC} is the number of hardware threads supported by the associated processor 105. This number of entries allows ITU 120 to keep “active” one gating storage 110 access from each thread context 115.

Controller 200 continues to add memory access instructions to request storage 125 as they are received, and continues to apply these memory access instructions to gating storage 110. At some point, depending on the occupancy of request storage 125 (RS), there may be multiple unsuccessful accesses and/or multiple untried memory access instructions in request storage 125. At this point, memory access instructions in request shelf 125 are arbitrated and sent out periodically to external interface 225. Arbitration is accomplished by controller 200 applying an arbitration policy to arbiter 205 which selects a particular one memory access instruction from request shelf 125 using multiplexer 210.

In the case of a ‘success’ (i.e., the memory access instruction is executed using the applicable memory access method modifier extracted from gating storage 110 that was related to the memory storage location referenced by the memory access instruction) ITU 120 sends back a response to processor 105ₚ over processor interface 220. Data and acknowledge are both sent back for a load type operation while an acknowledge is sent for a store type operation. An acknowledge is sent to processor 105ₚ (e.g. the LSU sends acknowledgment to the TSU) also, which moves that thread context 115ₚ state from blocked to runnable. The memory access instruction to ITU 120 completes and is deallocated from request storage 125.

In the case of a ‘fail’ (i.e., the memory access instruction is unable to be executed using the applicable memory access method modifier extracted from gating storage 110 that was related to the memory storage location referenced by the memory access instruction), ITU 120 performs any necessary housekeeping on management tag data associated with the stored memory access instruction. Whenever a new access is made to ITU 120, or an external event occurs on external ITU interface 220, ITU 120 retries all the outstanding requests in request storage 125, for example using a FCFS (First Come First Serve) arbitration policy. This preferred policy ensures fairness and is extendable in a multiprocessor situation.

On an exception being taken on a particular thread context 115ₚ or when thread context 115ₚ becomes halted, processor 105ₚ signals an abort for the outstanding ITC access of thread context 115ₚ. This abort signal causes ITU 120 to resolve a race condition (the “race” between aborting that operation or completing the operation which could have occurred in the few cycles it takes to cancel an operation) and accordingly to cancel or to complete the blocked memory access instruction operation and return a response to interface 220 (e.g., using IT_resp[2:0]). Processor 105 using interface 220 (e.g., using the IT_Cmd bus) requests a kill by signaling to ITU 120 (e.g., by asserting the kill signal on IT_Cmd along with the thread context ID (e.g. IT_cmd_tcid[PTC-1:0])). Processor 105 maintains the abort command asserted until it samples the kill response. ITU 120 responds to the abort with a three bit response, signaling abort or completion. The response triggers the LSU, which accordingly deallocates the corresponding load miss-queue entry. This causes the instruction fetch unit (IFU) to update the EPC [event driven process? undefined TLA] of the halting thread context 115ₚ accordingly. In other words, when the abort is successful, program counter 17 of the memory access instruction is used; but when the operation completes then program counter 17 of the next instruction (in program order) is used to update the EPC of thread context 115ₚ. For loads, ITU 120 returns a response and the LSU restarts thread context 115ₚ corresponding to the thread context ID on the response interface. For stores, ITU 120 returns an acknowledgment and, similar to the load, the LSU restarts the thread context.

According to the disclosure of US2005/0251639, synchronization between thread contexts 115 of different processors 105ᵢ requires another layer of intercommunications between ITUs 120 of their respective processor 105ᵢ. ITU 120 of each processor 105ᵢ is coupled to gating storage 110 (i.e., to memory 150 and to FIFO gating storage 155) as well as to each other ITU 120 of other processors 105ᵢ of system 100 for bi-directional communication. This intercommunication is needed, among other things, primarily to arbitrate access to the shared resource (i.e., the gated memory). Improvements to synchronization among threads in a multithreaded multiprocessing environment is desirable, particularly when individual threads may be active on more than one multiple processors.

There is thus a need for, and it would be highly advantageous to have, a system and method for synchronization between thread contexts of a system on a chip including multiple multithreaded processors which eliminates the need for multiple arbiters 205 and intercommunications 180 between multiple ITUs 120.

### BRIEF SUMMARY

According to an aspect of the present invention, there is provided a gated storage system including multiple control interfaces attached externally to respective multiple multithreaded processors. The multithreaded processors each have at least one thread context running an active thread so that multiple thread contexts are running on the multithreaded processors. A memory unit (e.g. FIFO and/or RAM) is connected to and shared between the multithreaded processors. The thread contexts request access to the gated memory by communicating multiple access requests over the control interfaces. The access requests originate from one or more of the thread contexts within one or more of the multithreaded processors. A single request storage is shared by the multithreaded processors. A controller stores the access requests in the single request storage. The access requests are typically from two or more of the thread contexts within two or more of the multithreaded processors. The multithreaded processors are optionally of different architectures, (e.g. MIPS and ARM). The system-level inter-thread communications unit is preferably the only inter-thread communications unit in the gated storage system. The controller and the request storage are preferably adapted for storing in the request storage, during a single clock cycle, one of the access requests from any of the multithreaded processors. The controller and the request storage are adapted for storing in the request storage, preferably during a single clock cycle, at least two of the access requests from at least two the multithreaded processors. The controller and the request storage are further adapted for deallocating one of the access requests, thereby removing the one access request from the request storage, during the single clock cycle while simultaneously accepting other access requests from the multithreaded processors. The controller is preferably adapted for handling a kill request from any of the multithreaded processors which removes from the request storage any of the access requests. The kill request is signaled to the controller via the external control interface along with an identifier identifying the thread context to be killed, upon which the controller appends an identifier identifying the requesting processor according to the external control interface from which the request was received (i.e., each interface is dedicated to a specific processor). The controller is preferably adapted for handling the access requests from any of the multithreaded processors by receiving via the control interfaces an identifier identifying the thread context.

According to another aspect of the present invention, there is provided a method for synchronization of thread contexts in a gated storage system. The gated storage system includes (a) external control interfaces connected to multithreaded processors and (b) memory connected to and shared between the multithreaded processors. An active thread is run in each of the multithreaded processors so that thread contexts run the active threads on the multithreaded processors. Access to the gated memory is requested by communicating access requests over the control interfaces. The access requests originate from any of the thread contexts within any of the multithreaded processors. A single request storage is shared by the multithreaded processors. All access requests from the multithreaded processors are stored in the single request storage. During a single clock cycle, one of the access requests is stored from any of the multithreaded processors. During a single clock cycle, at least two access requests are preferably stored from at least two of the multithreaded processors. One of the access requests is deallocated, by removing the one access request from the request storage during the single clock cycle. New access requests are stored in the same cycle as deallocation is effected. Access requests are handled from any of the multithreaded processors by receiving via the control interfaces at least one identifier identifying a thread context and a processor. A kill request is handled by removing from the request storage any access requests from any of the multithreaded processors by receiving via the control interfaces at least one identifier identifying at least one of the thread contexts. Multiple new access requests are stored in the same cycle as multiple kill requests effect deallocation (as well as standard deallocation due to servicing a pending request)

According to still another aspect of the present invention there is provided a system including multiple multi-threaded processors. Each multi-threaded processor is configured to have at least one thread context running at least one active thread. A system-level inter-thread communications unit includes multiple control interfaces. Each control interface connects respectively to one of the multi-threaded processors. A gated memory connects to the system-level inter-thread communications unit and is shared by the multithreaded processors. The thread contexts request access to the gated memory by communicating multiple access requests over the control interfaces. The access requests originate from any of the thread contexts within any of said multithreaded processors. A single request storage operatively connects to the control interfaces and a controller is adapted to store the access requests in the single request storage.

These, additional, and/or other aspects and/or advantages of the present invention are: set forth in the detailed description which follows; possibly inferable from the detailed description; and/or learnable by practice of the present invention.

### BRIEF DESCRIPTION OF THE DRAWINGS

The invention is herein described, by way of example only, with reference to the accompanying drawings, wherein:

FIG. 1 schematically illustrates a conventional multithreaded processor of MIPS architecture;

FIG. 1A schematically illustrates relevant details of a thread context (TC) which is part of the conventional multithreaded processor 105 of FIG. 1;

FIG. 1B is a simplified diagram of the system disclosed in US2005/0251639;

FIG. 2 is a schematic block diagram of the system of US 2005/0251639, which includes multiple (N) multithreaded processors 105ᵢ each coupled to a gating storage 110;

FIG. 3 is another schematic block diagram from US2005/0251639 illustrating more detail of the ITU 120 coupled to gating storage 110 as shown in FIG. 2;

FIG. 4 is a simplified block diagram of a system level interthread communications unit (system-level ITU) externally connected to two multi-threaded processors which share interthread communications storage (ITC Store) internal to the ITU, according to an aspect of the present invention;

FIG. 5 is a flow diagram which graphically illustrates a control method, in the system of FIG. 4;

FIG. 6 is a simplified block diagram of a system level interthread communications unit (system-level ITU), according to a preferred embodiment of the present invention, with synchronization between thread contexts of multiple multithreaded processors handled within a single Request Shelf,

FIG. 7 is a simplified block diagram of a general system architecture employing a system-level ITU to handle accesses from various processors to a shared memory resource; and

FIG. 8 is an illustration of a simplified method according to an aspect of the present invention.

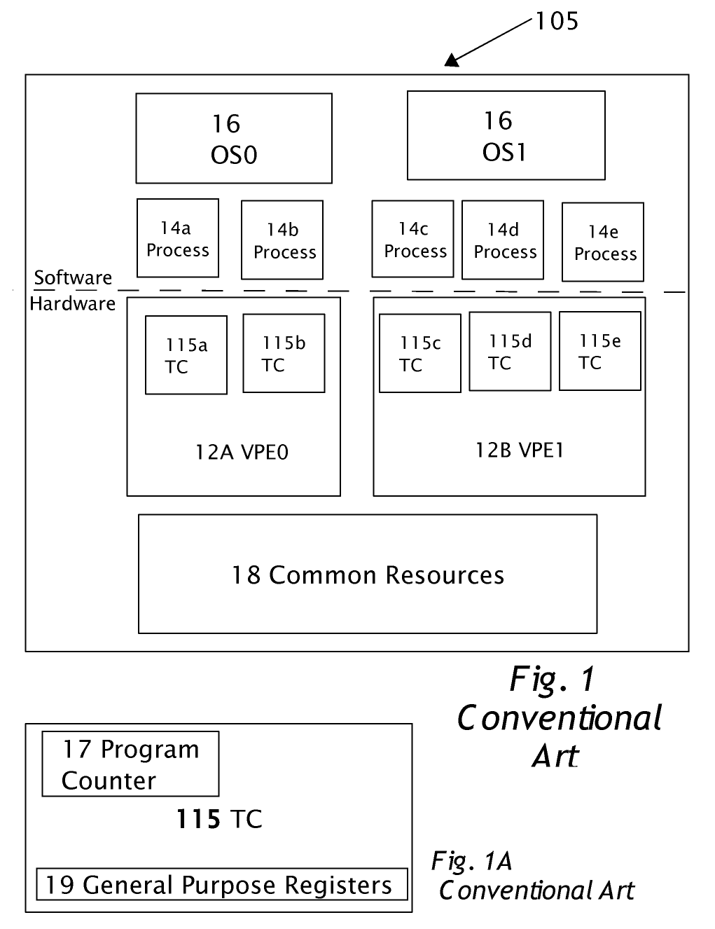

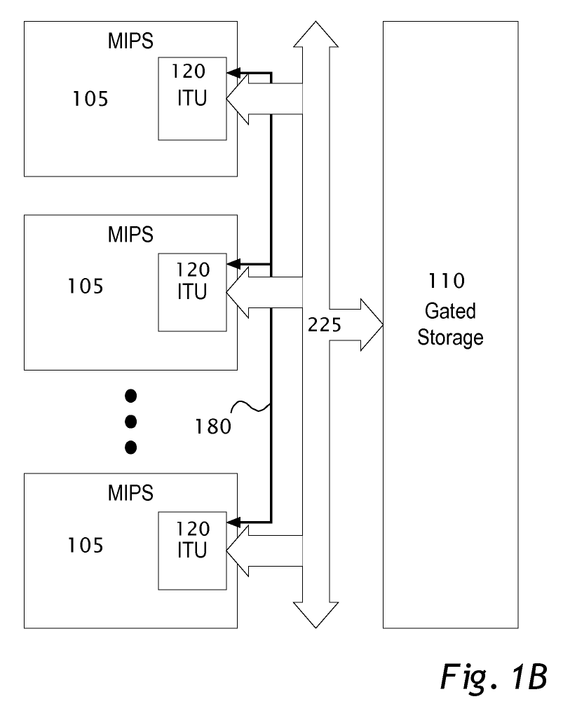

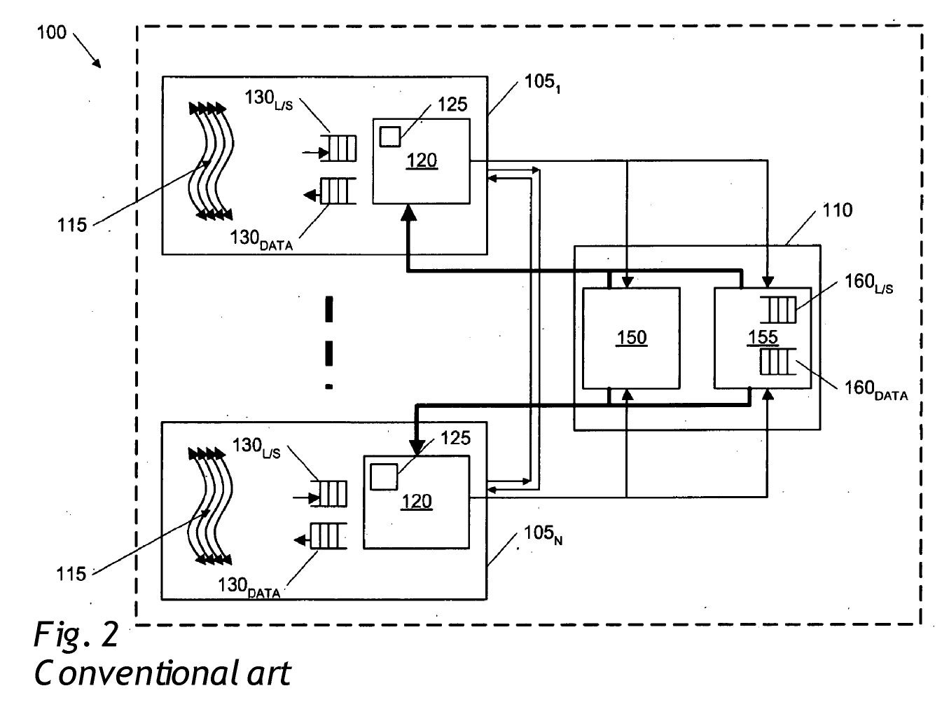

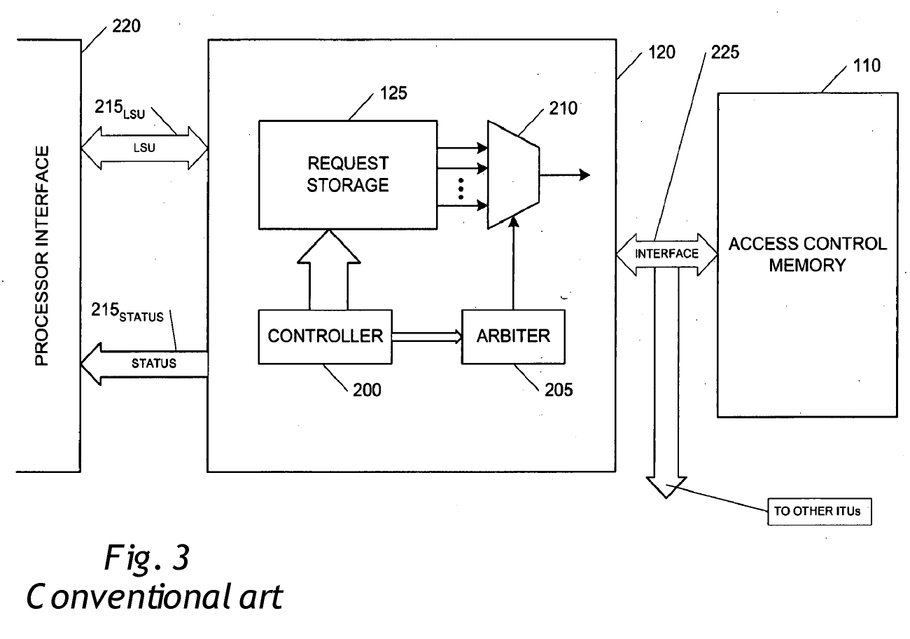

### DETAILED DESCRIPTION

Reference will now be made in detail to embodiments of the present invention, examples of which are illustrated in the accompanying drawings, wherein like reference numerals refer to the like elements throughout. The embodiments are described below to explain the present invention by referring to the figures.

It should be understood that although the following discussion relates multithreading MIPS processors, the present invention may implemented using other multithreaded processor architectures. Indeed, the inventors contemplate the application of this claimed invention to various other architectures.

Before explaining embodiments of the invention in detail, it is to be understood that the invention is not limited in its application to the details of design and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

By way of introduction, a principal intention of the present invention is to improve the synchronization between thread contexts of a system on a chip including multiple multithreaded processors. US2005/0251639 discloses InterThread Communications Unit (ITU) 120 which processes access requests from multiple thread contexts 115 within a single processor 105. While US2005/0251639 does disclose expandability to multiple processors 105, with multiple ITUs 120, the method disclosed performs task scheduling by signaling between all ITUs 120 of system 100. Specifically, in paragraph 0062, US2005/0251639 discloses the use of signaling, e.g. a strobe signal to indicate to all ITUs 120 that shared gated memory 110 has been updated. The strobe signal causes each ITU 120 to cycle through the pending requests in its request storage 125 (also known as request shelves 125). The approach disclosed in US patent application 2005/0251639 requires that all the ITUs 120 have to be wired to drive and accept strobes from each other. Furthermore, the approach disclosed in US2005/0251639 requires cycling through all the request shelves 125 upon every strobe signal.

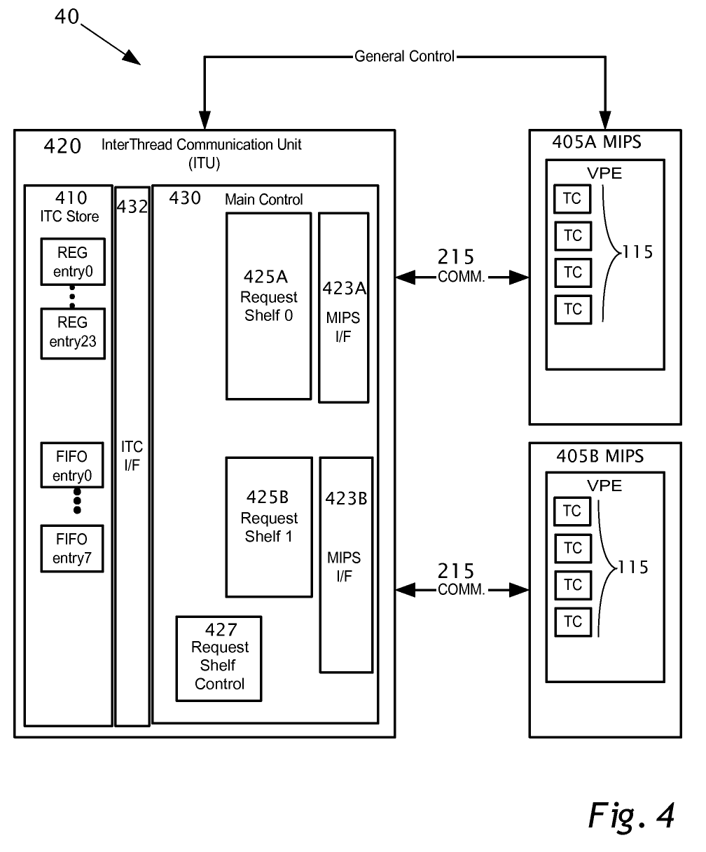

Referring now to the drawings, FIG. 4 illustrates a simplified block diagram of a system 40 of a system-level-interthread-communications unit 420 externally connected to two multi-threaded processors 405A and 405B which share interthread communications storage 410. System-level ITU 420 includes three primary elements: main control unit 430, ITC interface block 432 and ITC storage 410. Each processor 405 is connected to ITU 420 through a dedicated interface 423A and 423B. Signaling between processors 405 and respective interfaces 423, may preferably be in compliance with the standard as disclosed in US2005/0251639 for standard MIPS processors, e.g. MIPS 34K. system-level ITU 420 includes request shelf 425A and 425B which store requests respectively of thread contexts 115 of both processors 405A and 405B.

Request shelves 425A and 425B are controlled by a request shelf control block 427 which controls access of thread contexts 115 to request shelves 425A and 425B. Handling of the pending requests stored in request shelves 425A and 425B is event driven and performed in both request shelves 425A and 425B as data stored in gating storage 410 become available and valid. One method to handle pending requests stored in request shelves 425A and 425B is to include logic circuitry in control block 427 to alternate between request shelves 425A and 425B, thus always checking the other request shelf 405 for pending requests after processing one of request shelves 425A and 425B. Logic circuitry in block 427 may be designed so that pending requests that are not immediately handled are re-assessed following the processing of any requests.

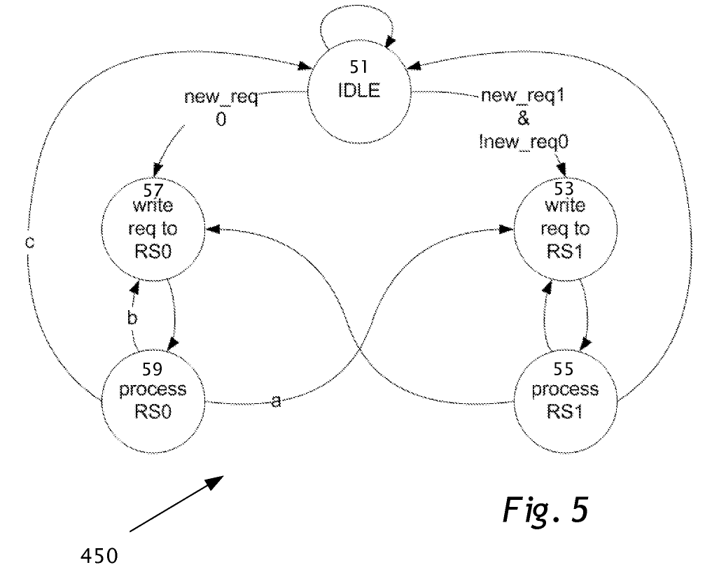

Reference is now made to FIG. 5, a flow diagram which graphically illustrates a method 450 used, in system 40, of cycling through pending requests in alternating fashion between those stored in request shelf 425A and those stored in request shelf 425B. An idle state 51 is entered (for instance in line (c)) when there are no pending requests from any thread context 115 of processors 405. From idle state 51, if a request is pending from processor 405A, the request is written (step 57) to request shelf 425A following which request shelf 425A is processed (step 59). Typically, if a new request arrives from processor 405B, the request is then written (step 53) to request shelf 425B following which request shelf 425B is processed (step 55). If two requests arrive simultaneously while in the idle state 51 then one of the processors is given precedence, e.g. 405A, such that its request is shelved (step 57) to shelf 425A and processed (step 59), after which the request from 405B is shelved (step 53) and processed (step 55). Similarly, if a request from one processor (e.g., 405A) comes while the control logic is already processing a request from the other processor (e.g., 405B), the new request is processed upon completion of the current request processing. If, on the other hand there is not a new request from the other processor, then the requests of current processor are continuously shelved and processed.

However, using system 40, there could be a scenario in which only thread context 115 in one processor, e.g. 405A is the data “producer” (i.e., always requests writing to locations in gated storage 410) and all other thread contexts 115, from both processors 405, in system 40, are data “consumers” (i.e., always request reading from the locations in gated storage 410). In such a case, in that control block 427 is configured to process requests in a fashion alternating between processors 405, the following result likely occurs: read requests are shelved in both request shelves 425; a write request shelved in request shelf 425A is processed and then a read request is processed from request shelf 425B. Similarly, every time a write is processed in request shelf 425A, a read request is subsequently processed in request shelf 425B, thus read requests pending in request shelf 425A are never processed. This issue may be addressed by tagging each shelf entry by an “arrival” number indicating when the request was shelved. Control block 427 is configured (in addition to checking whether the pending request may be performed) to read the arrival number tagging the pending requests in both request shelves giving precedence to the pending request of lowest arrival number. However, at some point, given a finite number of bits assigned for the arrival number field, the arrival numbers “wrap around” and start again from zero. Hence, all pending requests are preferably renumbered with new arrival numbers when the arrival number counter reaches a maximum.

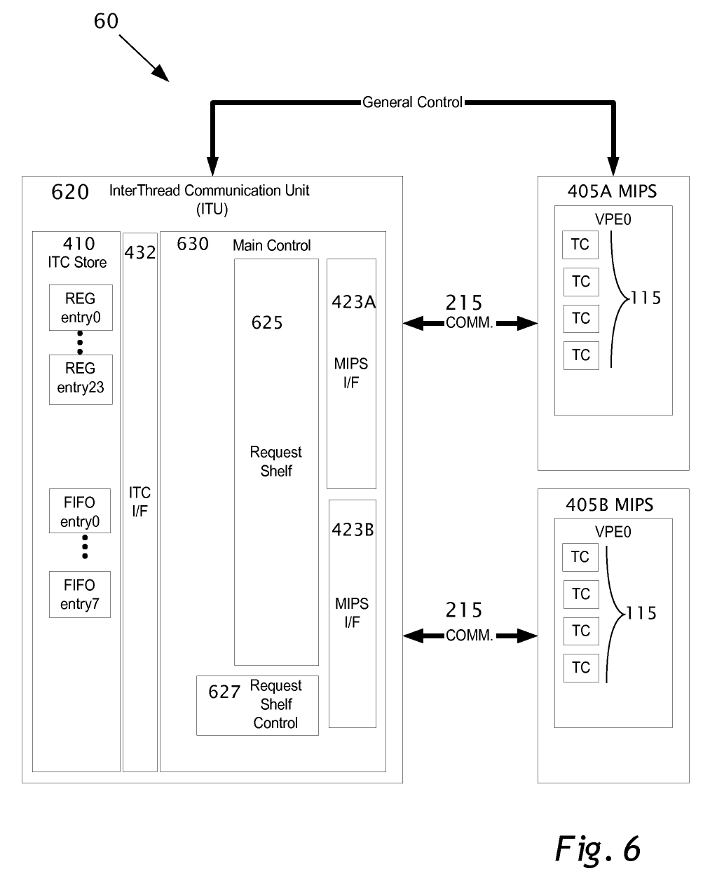

Reference is now made to FIG. 6 a simplified block diagram of a system 60 on chip, according to an embodiment of the present invention, with synchronization between thread contexts 115 of multithreaded processors 405A and 405B. A system level Interthread Communications Unit (system-level ITU) 620 is externally connected to two multi-threaded processors 405A and 405B which share Interthread Communications (ITC) storage 410. System-level ITU 620 includes three primary elements: main control unit 630, ITC interface block 432 and ITC storage 410. Each processor 405 is connected respectively to system-level ITU 620 through dedicated interfaces 423A and 423B. Signaling between processors 405 and respective interfaces 423, is preferably standard as disclosed in US 20050251639 for standard MIPS processors, e.g. MIPS 34K. System-level ITU 620 includes a single request shelf 625 which stores requests of thread contexts 115 of both processors 405A and 405B. Since, in this example there are two processors 405 which can perform accesses simultaneously, system-level ITU 620 is preferably configured to shelve two pending requests from both processors 405 during a single clock pulse. Request shelf 625 is controlled by request shelf control block 627 which is responsible for accepting memory access requests from thread contexts 115 and storing them to request shelf 625. Processing of the pending requests stored in request shelf 625 is performed by cycling through request shelf 625 and executing the requests as dictated by the exigencies of gating storage 410 (e.g., that valid data is available for a read request, that a memory location is available for a write request). Request shelf control block 627 is also responsible for removing processed requests and signaling such completion of execution to the requesting thread context.

A request shelf control block 627 preferably handles cycling through pending requests stored in request shelf 625. If there are no pending requests from any of processors 405 for accessing gating storage 410, then request shelf 625 is idle. Otherwise, if there is a pending request from one of processors 405, the request is shelved in request shelf 625 following which the request shelf is processed. If two requests arrive simultaneously, they are both shelved in the same clock cycle, the access from one processor is given precedence within the shelf, e.g., 405A, such that its request, higher up in the shelf is processed first. Access requests by the various system thread contexts to gated storage 410 are performed under control by request shelf control block 627. All requests are answered in turn by driving communication lines 215 with response data and relevant access information to the requesting processor 405; each processor 405 distinguishes between its thread contexts 115 using identifier lines 215 driven by ITU 620.

ITU storage 410 provides gating storage for inter-communication between all system thread contexts 115 including thread contexts 115 of different processors 405. As an example, ITC storage 410 has the following storage cells: 24 standard (non-FIFO) register cells, 8 FIFO registers of 64 bytes (16 entries of 32 bits). The number of entries, (e.g. 32 for the present example) are indicated on the IT_num_entries[10:0] lines which are driven to both of multithreaded processors 405.

A multithreaded processor 405, e.g. MIPS 34K, drives (blk grain) lines which define granularity or spacing between storage cell entries in ITC storage 410, for mapping cells out different pages of memory 410. Since system on chip (SoC) 60 employs multiple processors 405, e.g. two MIPS34K processor, these lines which define granularity may be handled appropriately so that all processors 405 use the same granularity. To allow for programmability, system-level ITU 620 may use grain lines (blk grain) from one designated multithreaded processor 405A and software may insure that other processors, e.g. MIPS 34K 405B uses the chosen granularity.

One of processors 405 accesses system-level ITU 620 by placing a command on lines 215, along with other relevant access information (e.g. id, addr, data). This data, along with the command, is referred to herein as “request data”. Strobes and/or enables are not required, instead, system-level ITU 620 accepts as a valid access every clock cycle during which there is active cmd data (i.e., read, write, kill) driven. A given thread context 115 does not drive another command (except for kill) until it has received a response from ITU 620 (on a dedicated signal line on COMM. I/F 215). On the next clock, however, another thread context 115 can drive “request data”. Request shelf 625 maintains one entry per thread context 115. It should be noted that though the kill command is an independent “request data” command that could come from thread context 115, there is no need to buffer the kill command in a unique shelf, but rather request shelf control block 627 modifies the currently buffered “request data” to be killed, thereby indicating to the request shelf logic 627 that the request is to be killed. Thus when the request shelf logic 627 is ready to process that shelf entry it notes that the “request data” is killed and thus deallocates the entry.

Deallocation of an entry is an operation performed when a command is killed and thus discarded from request shelf 625. Deallocation more commonly occurs when a shelf entry has been processed successfully. That is, in general, request shelf 625 fills up with access requests from various thread contexts 115 after which request shelf logic 627 looks at each request to decide if it can be processed or if it must remain in request shelf 625 till the storage location it is requesting to access is available. Once request shelf logic 627 determines that the request can be processed, request shelf logic 627 deallocates the request from the shelf, having granted the access so requested by thread context 115 in question.

Because system on chip (SoC) 60 has two processors 405 which can simultaneously (i.e., in the same clock cycle) drive valid “request data”, system-level ITU 620 can write to two registers within the single request shelf data structure 625 including e.g. 8 shelves (or registers) for each of eight thread contexts 115. In the event that two requests arrive simultaneously, the request from one processor, e.g. 405A is written to the highest available entry followed by the request from the other processor, e.g. 405B in the next highest entry. Priority is determined by convention.

Innovative handling is required to support multi-processor configuration 60:

In a configuration, e.g. system 100, with multiple processors 105ᵢ each with a dedicated ITU 120, a request from single multithreaded processor 105 is handled per single clock cycle. In configuration 60 respective requests from multiple multithreaded processors 405 are stored in request shelf 625 during a single clock cycle;
In a configuration, e.g. system 100, with multiple processors 105ᵢ each with a dedicated ITU 120, respective request shelf controllers 200 are configured to deallocate an entry in request shelf 125 while request shelf 125 is simultaneously (during a single clock cycle) being written into by a request from single processor 105ᵢ. In configuration 60 request shelf controller 627 and request shelf 625 are configured to handle a deallocate operation while simultaneously (during a single clock cycle) storing N requests from each of N multithreaded processors, e.g. two requests from two multithreaded processors 405A and 405B;
In a configuration, e.g. system 100, with multiple processors 105ᵢ each with a dedicated ITU 120, respective request shelf controllers 200 are configured to process a single kill command and associated thread context identifier (tcid) of one of the thread contexts 115 of a single processor 105ᵢ. In configuration 60, kill commands and associated thread context identifiers (tcid) are processed by controller 627 simultaneously (during a single clock cycle) from each of multiple processors 405; and
In a configuration, e.g. system 100, with multiple processors 105ᵢ each with a dedicated ITU 120 a given shelf entry or register includes data defining the access request from one of thread contexts 115. In configuration 60, additional bits are appended to each shelf entry indicating from which processor 405 the request originates. When the stored command is later processed, the correct bus 215 is driven which corresponds to multithreaded processor 405 which originated the access request.

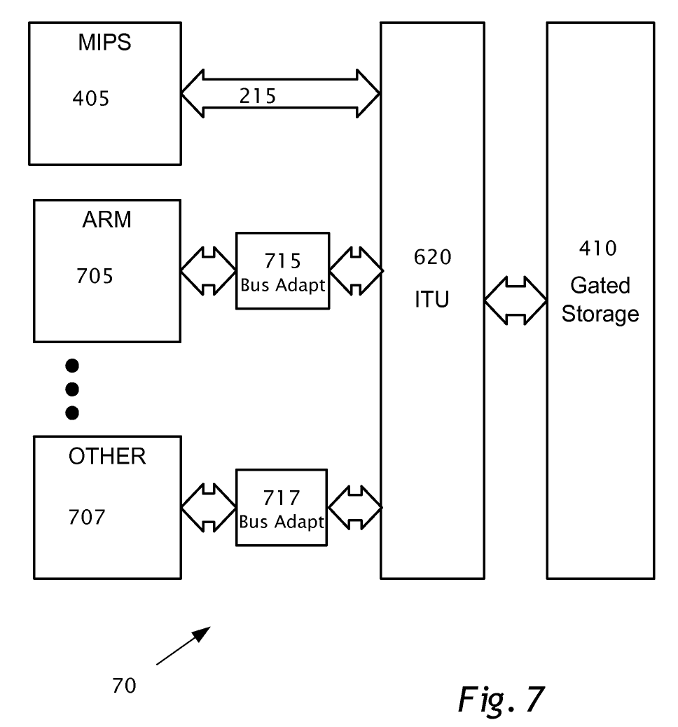

Reference is now made to FIG. 7, a simplified block diagram of a system 70 which illustrates another feature of the present invention. System 70 includes processors MIPS 105, ARM (Advanced RISC microprocessor) 705 and another 707 of arbitrary architecture all sharing gated storage 410. System level ITU 620 controls access to gated storage 410. Signaling interface 215 is used between MIPS 105 and ITU 620. Bus adapters 715, 717 may be used to adapt the signaling of signaling interface 215 to the corresponding signals of respective processors 705 and 707. Processors 705, 707 are optionally single or multi-threaded processors, and/or single or multiple core processors.

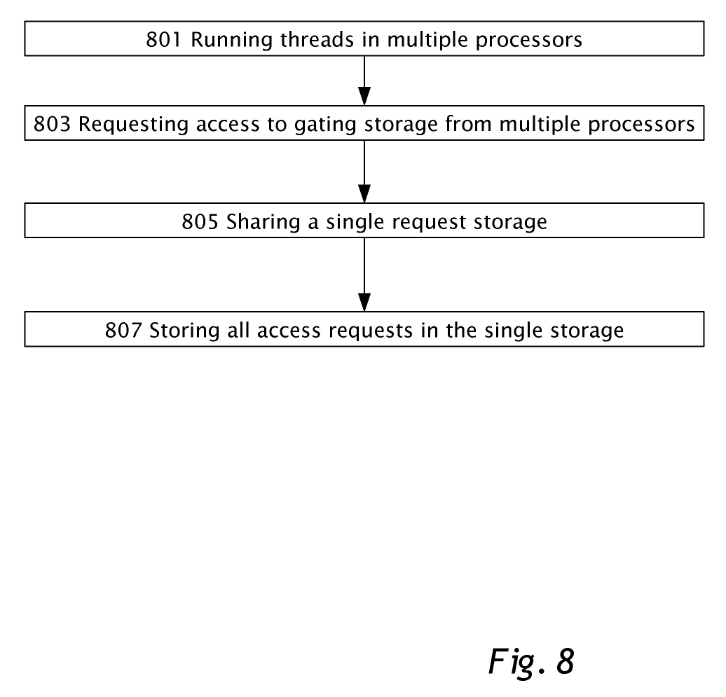

Reference is now also made to FIG. 8, illustrating a method according to an aspect of the present invention. Multiple threads are running (step 801) in multiple multithreaded processors 105, 705, and 707. The multiple processors request (step 803) access to gated storage 410. Requests which cannot be processed are stored in a single request storage shared (step 805) by multiple multithreaded processors 105, 705, and 707. Waiting access requests from multiple multithreaded processors 105 are stored (step 807) in the single gated storage 410.

Although selected embodiments of the present invention have been shown and described, it is to be understood that the present invention is not limited to the described embodiments. Instead, it is to be appreciated that changes may be made to these embodiments without departing from the principles and spirit of the invention, the scope of which is defined by the claims and the equivalents thereof.

We claim:

1. A gated-storage system comprising:
a plurality of control interfaces, each control interface operatively connected externally to a respective one of a plurality of multi-threaded processors each having at least one thread context running at least one active thread so that a plurality of said thread contexts are running on said multithreaded processors;
a memory operatively connected to a system-level inter-thread communications unit and shared between the multithreaded processors, wherein said thread contexts request access to said memory by communicating a plurality of access requests over said control interfaces, said access requests originating from any of said thread contexts within any of said multithreaded processors;
a single request storage shared by the multithreaded processors; and
a controller adapted to store said access requests in said request storage.

2. The system, according to claim 1, wherein said access requests are from at least two of said thread contexts and from at least two of said multithreaded processors.

3. The system, according to claim 1, wherein said multithreaded processors are of at least two different architectures.

4. The system, according to claim 1, wherein said system-level inter-thread communications unit is a single inter-thread communications unit in the gated storage system.

5. The system, according to claim 1, wherein said controller and said request storage are adapted to store, in said request storage, during a single clock cycle, one of said access requests from any of said multithreaded processors.

6. The system, according to claim 1, wherein said controller and said request storage are adapted to store, in said request storage, during a single clock cycle, at least two of said access requests from least two said multithreaded processors.

7. The system, according to claim 6, wherein, during said single clock cycle, said controller and said request storage are further adapted to deallocate one of said access requests, thereby removing said one access request from said request storage, while simultaneously accepting others of said access requests from said multithreaded processors.

8. The system, according to claim 1, wherein said controller is adapted to handle a kill request and thereby removing from said request storage any of said access requests from any of said multithreaded processors by receiving, via said plurality of control interfaces, at least one identifier identifying at least one of said thread contexts.

9. The system, according to claim 1, wherein said controller is adapted for handling said access requests from any of said multithreaded processors by receiving via said control interfaces at least one identifier identifying at least one of said thread contexts.

10. In a gated-storage system including a plurality of control interfaces operatively attached externally to a respective one of a plurality of multithreaded processors and a gated memory operatively connected to a system-level inter-thread communications unit and shared between the multithreaded processors, a method for synchronization of data comprising:
running at least one active thread in each of the multithreaded processors by a plurality of thread contexts on the multithreaded processors;
requesting access to the gated memory by communicating a plurality of access requests over said control interfaces, said access requests originating from any said thread contexts within any of the multithreaded processors;
sharing a single request storage by the multithreaded processors; and
storing all access requests from the multithreaded processors in said single request storage.

11. The method according to claim 10, further comprising storing, in said request storage, during a single clock cycle, one of said access requests from any of the multithreaded processors.

12. The method according to claim 10, further comprising storing, in said request storage, during a single clock cycle, at least two access requests from at least two of the multithreaded processors.

13. The method according to claim 12, further comprising deallocating one of said access requests, thereby removing said one access request from said request storage during said single clock cycle.

14. The method according to claim 10, further comprising handling access requests from any of the multithreaded processors by receiving, via said control interfaces, at least one identifier identifying any of said thread contexts.

15. The method according to claim 10, further comprising handling a kill request and thereby removing from said request storage any access requests from any of the multithreaded processors by receiving via said control interfaces at least one identifier identifying at least one of said thread contexts.

16. A system comprising:
a plurality of multi-threaded processors, each multi-threaded processor configured to have at least one thread context running at least one active thread;
a system-level inter-thread communications unit that includes a plurality of control interfaces, each control interface operatively connecting to a respective one of the plurality of multi-threaded processors,
a gated memory operatively connecting to the system-level inter-thread communications unit, and shared by the multithreaded processors, wherein the thread contexts request access to said gated memory by communicating a plurality of access requests over said control interfaces, said access requests originating from any of said thread contexts within any of said multithreaded processors;
a single request storage operatively connected to the control interfaces; and
a controller adapted to store said access requests in said single request storage.
